(19) United States
(12) Patent Application Publication
(10) Pub. No.: US 2025/0092169 A1
(43) Pub. Date: Mar. 20, 2025

(54) METHACRYLIC RESIN AND METHOD FOR PRODUCING SAME, RESIN COMPOSITION, DOPE, AND RESIN FILM

(71) Applicant: KANEKA CORPORATION, Osaka (JP)

(72) Inventors: Takefumi Furuta, Osaka (JP); Yoshio Furukawa, Osaka (JP)

(73) Assignee: KANEKA CORPORATION, Osaka (JP)

(21) Appl. No.: 18/968,866

(22) Filed: Dec. 4, 2024

Related U.S. Application Data
(63) Continuation-in-part of application No. PCT/JP2023/021126, filed on Jun. 7, 2023.

(30) Foreign Application Priority Data
Jun. 7, 2022 (JP) 2022-092344

(51) Int. Cl. C08F 20/14

(52) U.S. Cl. CPC C08F 20/14

(57) ABSTRACT

A methacrylic resin includes a structural unit derived from methyl methacrylate in a proportion of 98% by mass or more. The methacrylic resin has a weight average molecular weight (Mw) as measured by gel permeation chromatography (GPC) of 400,000 or more, a triad syndiotacticity of 55% to 70% inclusive, a 5% weight loss temperature of 300° C. or higher, and a proportion of terminal double bonds to a structural unit derived from methyl methacrylate of less than 0.015 mol %. A method for producing the methacrylic resin is provided. A resin composition and a dope including the methacrylic resin, a resin film including the methacrylic resin, and a polarizing plate and a display device in which the resin film is used, are provided.

### TECHNICAL FIELD

One or more embodiments of the present invention relate to a methacrylic resin and a method for producing the same, a resin composition, dope, and a resin film.

### BACKGROUND

Methacrylic resins are widely used in various fields because they have excellent transparency, weather resistance, processability, and the like. In particular, a resin film obtained by molding a methacrylic resin is also used in optical applications such as display devices because of its excellent optical properties.

As a method for producing the resin film, a melt extrusion method using a T-die, a solution casting method in which a dope obtained by dissolving a resin in a solvent is cast on the surface of a support and then the solvent is evaporated to form a film, and the like are known. Among them, the solution casting method is advantageous in that since physical stress applied to the resin film during film formation is small, orientation of the polymer is unlikely to occur, and the strength and optical properties of the obtained resin film are isotropic. In addition, according to the solution casting method, there is an advantage that thickness accuracy of the obtained resin film is extremely high.

When the resin film is produced by the solution casting method, a methacrylic resin with a high molecular weight is generally used as the methacrylic resin. Use of a methacrylic resin with a high molecular weight not only makes it suitable for the solution casting method but also makes it possible to obtain a resin film having good mechanical properties.

### Patent Document

Patent Document 1: PCT International Publication No. WO2019/167471

However, as a result of investigation by the present inventors, it has been found that such a high-molecular-weight methacrylic resin has room for improvement in terms of heat resistance and thermal stability.

### SUMMARY

One or more embodiments of the present invention provide a methacrylic resin excellent in heat resistance and thermal stability and capable of producing a molded article excellent in mechanical strength and a method for producing the same, a resin composition and a dope containing the methacrylic resin, a resin film containing the methacrylic resin, and a polarizing plate and a display device including the resin film.

The above includes the following embodiments.
<1> A methacrylic resin including a structural unit derived from methyl methacrylate in a proportion of 98% by mass or more,
in which the methacrylic resin has:
a weight average molecular weight (Mw) as measured by gel permeation chromatography (GPC) of 400,000 or more,
a triad syndiotacticity of 55% to 70% inclusive,
a 5% weight loss temperature of 300° C. or higher, and
a proportion of terminal double bonds to the structural unit derived from methyl methacrylate of less than 0.015 mol %.
<2> The methacrylic resin as described in <1>, in which a ratio (Mw/Mn) of a weight average molecular weight (Mw) to a number average molecular weight (Mn) is 1.6 to 2.8 inclusive.
<3> The methacrylic resin as described in <1>, in which a chain transfer agent residual proportion is 0.005% by mass or less.
<4> The methacrylic resin as described in <2>, in which the chain transfer agent residual proportion is 0.005% by mass or less.
<5> The methacrylic resin as described in any one of <1> to <4>, including a terminal structure derived from a polymerization initiator and represented by the following formula (1):

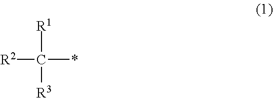

in the formula, R¹, R², and R³ each independently represent an alkyl group, a substituted alkyl group, an ester group, or an amide group, provided that at least one of R¹, R², or R³
represents an ester group or an amide group, two of R¹, R², or R³ may be bonded to each other to form an alicyclic structure, and * represents a bond to a structural unit derived from a monomer.
<6> The methacrylic resin as described in any one of <1> to <5>, having a glass transition temperature of 120° C. or more.
<7> A methacrylic resin comprising a structural unit derived from methyl methacrylate in a proportion of 98% by mass or more,
wherein the methacrylic resin has:
a weight average molecular weight (Mw) as measured by gel permeation chromatography (GPC) of 400,000 or more,
a triad syndiotacticity of 55% or more,
a 5% weight loss temperature of 300° C. or higher,
a proportion of terminal double bonds to a structural unit derived from methyl methacrylate of less than 0.015 mol %, and
a glass transition temperature of 120° C. to 135° C. inclusive.
<8> A method for producing a methacrylic resin, including:
a polymerization step of polymerizing a monomer mixture having a methyl methacrylate content of 98% by mass or more at a temperature lower than 100° C. in the presence of a polymerization initiator and a chain transfer agent until a polymerization conversion ratio reaches 90% or more,
in which an amount of the chain transfer agent to be used is 0.03 mol % or less with respect to a total amount of the monomer mixture, and
a ratio of a total molar amount of the chain transfer agent to
a total molar amount of the polymerization initiator is 1.6 or less.
<9> The method for producing a methacrylic resin as described in <8>, in which the polymerization initiator is a non-nitrile azo polymerization initiator.
<10> The method for producing a methacrylic resin as described in <8> or <9>, in which aqueous polymerization is performed in the polymerization step.
<11> The method for producing a methacrylic resin as described in any one of <8> to <10>, in which in the polymerization step, polymerization is performed until the chain transfer agent residual proportion reaches 0.005% by mass or less.
<12> A resin composition including the methacrylic resin as described in any one of <1> to <7> and optionally multilayer structure polymer particles.
<13> A dope for use in film formation by a solution casting method, the dope containing the methacrylic resin as described in any one of <1> to <7> and a solvent, in which the solvent includes a first solvent having a hydrogen bond term &H in a Hansen solubility parameter of 1 to 12 and a second solvent having the hydrogen bond term OH of 14 to 24.
<14> A resin film including the methacrylic resin as described in any one of <1> to <7>.
<15> The resin film as described in <14>, in which a number of folds until break in a clamshell-type folding test is 6,000 times or more.
<16> The resin film as described in <14> or <15>, including multilayer structure polymer particles.
<17> The resin film as described in <14> or <16>, in which the resin film is an optical film.
<18> The resin film as described in <14> or <17>, in which the resin film is a polarizer protective film.
<19> A polarizing plate formed by laminating a polarizer and the resin film as described in any one of <14> to <18>.
<20> A display device including the polarizing plate as described in <19>.

According to one or more embodiments of the present invention, it is possible to provide a methacrylic resin excellent in heat resistance and thermal stability and capable of producing a molded article excellent in mechanical strength and a method for producing the same, a resin composition and a dope containing the methacrylic resin, a resin film containing the methacrylic resin, and a polarizing plate and a display device including the resin film.

### DETAILED DESCRIPTION

Hereinafter, one or more embodiments of the present invention will be described in detail. The symbol “-” representing a numerical range is used to include the lower limit and the upper limit of the range, unless otherwise specified.

### <Methacrylic Resin>

In the methacrylic resin according to one or more embodiments, a proportion of a structural unit derived from methyl methacrylate is 98% by mass or more, and a proportion of a structural unit derived from a monomer other than methyl methacrylate is 2% by mass or less. In the methacrylic resin according to one or more embodiments, the proportion of a structural unit derived from methyl methacrylate is 99% by mass or more, or 100% by mass (that is, the methacrylic resin is a homopolymer of methyl methacrylate). Note that the structural unit derived from methyl methacrylate is represented by the following formula.

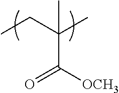

Examples of monomers other than methyl methacrylate include alkyl esters of acrylic acid such as methyl acrylate, ethyl acrylate, propyl acrylate, butyl acrylate, 2-ethylhexyl acrylate, etc.; aryl esters of acrylic acid, such as phenyl acrylate; cycloalkyl esters of acrylic acid, such as cyclohexyl acrylate, norbornenyl acrylate, etc.; alkyl esters of methacrylic acid other than methyl methacrylate, such as ethyl methacrylate, propyl methacrylate, butyl methacrylate, etc.; aryl esters of methacrylic acid such as phenyl methacrylate; cycloalkyl esters of methacrylate such as cyclohexyl methacrylate, norbornenyl methacrylate, etc.; aromatic vinyl compounds such as styrene, α-methylstyrene, etc.; acrylamides; methacrylamides; acrylonitrile; methacrylonitrile; and the like.

The methacrylic resin according to one or more embodiments has a weight average molecular weight (Mw) of 400,000 or more. When the weight average molecular weight (Mw) of the methacrylic resin is 400,000 or more, the mechanical properties of a molded article to be obtained tend to be improved, and for example, a resin film excellent in folding endurance can be obtained. The weight average molecular weight (Mw) of the methacrylic resin may be 600,000 or more, 700,000 or more, or 800,000 or more. The upper limit of the weight average molecular weight (Mw) is not particularly limited, but from the viewpoint of moldability, may be 4 million or less, 3.5 million or less, 3 million or less, 2.5 million or less, 2 million or less, or 1.5 million or less.

Further, the methacrylic resin according to one or more embodiments has a dispersity (Mw/Mn), i.e., a ratio of the weight average molecular weight (Mw) to the number average molecular weight (Mn), of 1.6 to 2.8, 1.7 to 2.5, 1.7 to 2.4, or 1.7 to 2.3. When the dispersity (Mw/Mn) of the methacrylic resin is 1.6 or more, fluidity of the methacrylic resin is improved and the resin is easier to mold. When the dispersity (Mw/Mn) of the methacrylic resin is 2.8 or less, mechanical properties such as impact resistance, toughness, and folding endurance of the molded article to be obtained tend to be improved.

In the present specification, the weight average molecular weight (Mw) and the number average molecular weight (Mn) are values in terms of standard polystyrene measured by gel permeation chromatography (GPC), and are measured by the method described in Examples below.

Note that the weight average molecular weight (Mw) and the number average molecular weight (Mn) of the methacrylic resin can be controlled by adjusting the types, amounts to be used, etc. of the polymerization initiator and the chain transfer agent in synthesizing the methacrylic resin.

The methacrylic resin according to one or more embodiments has a triad syndiotacticity (rr) of 55% or more, 56% or more, or 57% or more. When the triad syndiotacticity (rr) is 55% or more, glass transition temperature (Tg) of the methacrylic resin becomes high, and the heat resistance tends to be improved. The upper limit of the syndiotacticity (rr) is not particularly limited, but may be 70% or less, 67% or less, 65% or less, or 63% or less from the viewpoints of molding temperature and toughness and secondary workability of a molded article.

The syndiotacticity (rr) refers to a percentage that two successive chains (diad) possessed by a chain (triad) composed of three successive structural units are both racemo (rr). Note that, in a chain (diad) of structural units in a polymer molecule, a diad having the same steric configuration is referred to as meso, and a diad having reversed steric configurations is referred to as racemo, the meso and the raceme being denoted by m and r, respectively.

As described in Examples below, the syndiotacticity (rr) can be calculated using formula: (X/Y)×100, where X and Y are an area (X) of a region of 0.60 to 0.95 ppm and an area (Y) of a region of 0.60 to 1.25 ppm, respectively, provided that X and Y are measured from a 1H-NMR spectrum measured in deuterated chloroform at 22° C. for 16 integrations, when tetramethylsilane (TMS) is assigned as 0 ppm.

The methacrylic resin according to one or more embodiments has a glass transition temperature (Tg) of 120° C. or higher, 122° C. or higher, or 124° C. or higher. The upper limit of the glass transition temperature (Tg) is not particularly limited, but may be 135° C. or less, and may be 130° C. or less from the viewpoints of molding temperature and secondary workability of the molded article.

In the present specification, the glass transition temperature (Tg) is a midpoint glass transition temperature determined from a DSC curve, and is measured by the method described in the Examples described below.

The syndiotacticity (rr) and glass transition temperature (Tg) of a methacrylic resin can be controlled by adjusting a polymerization temperature when synthesizing the methacrylic resin. For example, lowering the polymerization temperature is preferable in increasing the syndiotacticity (rr) of the methacrylic resin and increasing the glass transition temperature (Tg). The glass transition temperature (Tg) can also be controlled by adjusting the molecular weight of the methacrylic resin.

In addition, the methacrylic resin according to one or more embodiments has a 5% weight loss temperature of 300° C. or more, and has excellent thermal stability.

In general, when producing a resin with a large molecular weight, a technique of reducing an amount of a chain transfer agent and/or a polymerization initiator to be used is employed. However, when, for example, a thiol compound is used as the chain transfer agent, the proportion of growing radicals that are terminated by a hydrogen abstraction reaction from the chain transfer agent decreases, and a relatively large number of polymers having double bond terminals are likely to be produced by a disproportionation termination reaction between growing radicals. It is known that the terminal double bond is thermally decomposed at a lower temperature than the main chain of the methacrylic resin (For example, T. Kashiwagi, et al., Macromolecules, 1986, 19, pp. 2160-2168, or the like), which causes deterioration of the thermal stability of the resin. In this regard, in the methacrylic resin according to one or more embodiments, a ratio between an amount of chain transfer agent and an amount of polymerization initiator during the production is adjusted to an appropriate range, thereby reducing the proportion of terminal double bond. As a result, although the weight average molecular weight (Mw) of the methacrylic resin according to one or more embodiments has a high molecular weight of 400,000 or more, the 5% weight loss temperature can be adjusted to 300° C. or more.

The 5% weight loss temperature in the present specification is a temperature determined from a thermogravimetric curve, and is measured by the method described in the Examples below.

In the methacrylic resin according to one or more embodiments, the proportion of terminal double bonds to structural units derived from methyl methacrylate is less than 0.015 mol %, less than 0.010 mol %, or less than 0.006 mol %, from the viewpoint of adjusting the 5% weight loss temperature to 300° C. or more.

The methacrylic resin according to one or more embodiments can be produced by a radical polymerization method as shown in the production method described later. The methacrylic resin produced by the radical polymerization method contains a terminal double bond generated by a disproportionation termination reaction during polymerization, a hydrogen abstraction reaction of a monomer by a polymerization initiator, or the like. Since the terminal double bond affects the thermal stability of the resin, a proportion thereof may be small. The proportion of terminal double bonds is controlled by the method described below, and if the ratio can be reduced to a range of less than 0.015 mol %, the thermal stability of the methacrylic resin tends to be significantly improved. Note that the lower limit of the terminal double bond proportion may be 0 mol %, but may be 0.001 mol %.

The proportion of terminal double bonds to the structural unit derived from methyl methacrylate can be determined by, as described in the Examples below, measuring a 1H-NMR spectrum in deuterated chloroform at 20° C. for an integration number of 8,192 times; measuring a total area (X) of peaks (5.47 to 5.52 ppm and 6.21 ppm) derived from the terminal double bond portion of the methacrylic resin and an area (Y) of peaks (0.5 to 1.25 ppm) derived from an x-methyl group of the methacrylic resin from the spectrum; and calculating the ratio using the formula: [(3×X)/(2×Y)]×100.

The proportion of terminal double bonds of the methacrylic resin can be controlled by adjusting amounts of the polymerization initiator and the chain transfer agent to be used in synthesizing the methacrylic resin, the polymerization temperature, the polymerization time, and the like. For example, it is preferable to reduce the amount of the polymerization initiator to be used, to increase the amount of the chain transfer agent to be used, to lower the polymerization temperature, and to increase the polymerization time in order to reduce the proportion of terminal double bonds.

The methacrylic resin according to one or more embodiments includes a terminal structure represented by the following formula (1), the structure being derived from a polymerization initiator.

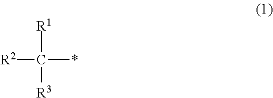

In the formula, R¹, R², and R³ each independently represent an alkyl group, a substituted alkyl group, an ester group, or an amide group; however, at least one of R¹, R², or R³ represents an ester group or an amide group; two of R¹, R², and R³ may be bonded to each other to form an alicyclic structure; and * represents a bond to a structural unit derived from the monomer.

Examples of the alkyl group include a linear or branched alkyl group having 1 to 6 carbon atoms. Examples of the substituent that the alkyl group may have include a hydroxy group, a carboxy group, an alkoxy group, a halogen atom, etc.

Examples of the ester group include a group represented by —COOR⁴. R⁴ represents an alkyl group having 1 to 6 carbon atoms, and may have a substituent such as a hydroxy group, a carboxy group, an alkoxy group, a halogen atom, or the like.

Examples of the amide group include a group represented by —C(O)NR⁵. R⁵ represents an alkyl group having 1 to 6 carbon atoms, a cycloalkyl group, or an alkenyl group having 2 to 6 carbon atoms, and may have a substituent such as a hydroxy group, a carboxy group, an alkoxy group, a halogen atom, or the like.

The terminal structure represented by the above formula (1) can be introduced into the molecule of the methacrylic resin by using a non-nitrile azo polymerization initiator represented by the following formula (2) when synthesizing the methacrylic resin. In the formula, R¹, R², and R³ are as defined in the above formula (1). Use of such a non-nitrile azo polymerization initiator tends to improve the thermal stability of the methacrylic resin to be obtained as compared with a case of using a polymerization initiator other than the non-nitrile azo polymerization initiator (for example, a nitrile azo polymerization initiator). In addition, the non-nitrile azo polymerization initiator is preferable in that the toxicity of the initiator itself and/or decomposition products tends to be lower than that of the nitrile azo polymerization initiator.

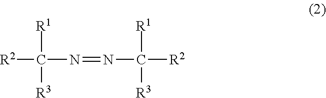

Examples of the non-nitrile azo polymerization initiator represented by the above formula (2) include dimethyl 2,2′-azobis(isobutyrate), 1,1′-azobis(cyclohexanecarboxylic acid methyl) ester, 2,2′-azobis [N-(2-propenyl)-2-methylpropionamide], 2,2′-azobis(N-butyl-2-methylpropionamide), 2,2′-azobis(N-cyclohexyl-2-methylpropionamide), 2,2′-azobis {2-methyl-N-[2-(1-hydroxyethyl)]propionamide}, 2,2′-azobis {2-methyl-N-[2-(1-hydroxybutyl)]propionamide}, etc. Among these, at least one selected from dimethyl 2,2′-azobis(isobutyrate) or 1,1′-azobis(cyclohexanecarboxylic acid methyl) ester is preferable from the viewpoints of half-life temperature, cost, and the like.

In the methacrylic resin according to one or more embodiments, the chain transfer agent residual proportion is 0.005% by mass or less (that is, the proportion of the chain transfer agent remaining in the resin is small). The lower limit of the chain transfer agent residual proportion is not particularly limited, and may be substantially 0% by mass (that is, less than the detection limit). The chain transfer agent residual proportion is measured by the method described in the Examples below.

The methacrylic resin according to one or more embodiments is not only excellent in heat resistance and thermal stability, but also expected to be suitable for reuse after disposal, that is, for recycling. As a method of recycling a methacrylic resin, for example, chemical recycling (method for recovering cracked oil as a cracked product by thermal cracking and reusing it as a chemical raw material or fuel) is known. In general, in order to improve the heat resistance and thermal stability of a methacrylic resin, a cyclic structure is introduced into the molecular structure of the methacrylic resin, or a monomer having a rigid structure is copolymerized. However, these structures are unpreferable, because they are impurities in chemical recycling. In this regard, since the methacrylic resin according to one or more embodiments includes a large proportion of the structural unit derived from methyl methacrylate, and the monomer is expected to be recovered as cracked oil in a high yield, good chemical recyclability can be expected.

### <Method for Producing Methacrylic Resin>

A method for producing the methacrylic resin according to one or more embodiments includes a polymerization step of polymerizing a monomer mixture having a methyl methacrylate content of 98% by mass or more in the presence of polymerization initiator and a chain transfer agent at a temperature less than 100° C. until the polymerization conversion ratio reaches 90% or more. In the polymerization step, the polymerization may be performed until the chain transfer agent residual proportion reaches 0.005% by mass or less.

As a method for producing the methacrylic resin, a conventionally known polymerization method can be employed, and for example, a radical polymerization method such as a continuous bulk polymerization method, a solution polymerization method, an emulsion polymerization method, a non-emulsifier (soap-free) emulsion polymerization method, or a suspension polymerization method can be employed. Among them, from the viewpoints of a degree of freedom in structural design of the methacrylic resin, simplicity of polymerization, productivity, etc., a production method in which aqueous polymerization is performed is preferable, a suspension polymerization method and an emulsion polymerization method are more preferable, and a suspension polymerization method is further preferable.

### [Suspension Polymerization Method]

In the suspension polymerization method, the methacrylic resin is synthesized in an aqueous suspension in which water, a monomer mixture, a dispersant, a polymerization initiator, a chain transfer agent, and optionally other additives are mixed. The order of mixing components is not particularly limited. For example, an aqueous suspension may be prepared by mixing the components simultaneously. Alternatively, water, a polymerization initiator, and optional other additives may be mixed to prepare an aqueous solution, followed by addition of the monomer mixture and the chain transfer agent, followed by addition of a dispersant to prepare the aqueous suspension. A mass ratio of the methacrylic resin to be obtained to water (methacrylic resin/water) may be 1.0/0.6 to 1.0/3.0.

As the monomer mixture, a monomer mixture in which the content of methyl methacrylate is 98% by mass or more, 99% by mass or more, or 100% by mass may be used.

Examples of the dispersant include sparingly water-soluble inorganic salts such as calcium triphosphate, magnesium pyrophosphate, hydroxyapatite, kaolin, etc.; water-soluble polymers such as polyvinyl alcohol, methyl cellulose, polyacrylamide and polyvinylpyrrolidone; and the like. When a sparingly water-soluble inorganic salt is used as the dispersant, it is effective to use an anionic surfactant such as sodium α-olefinsulfonate, sodium dodecylbenzenesulfonate, or the like, in combination. These dispersants may be added during the polymerization as necessary.

As the polymerization initiator, known polymerization initiators can be used, including azo polymerization initiators such as dimethyl 2,2′-azobis(isobutyrate), 2,2′-azobis(2,4-dimethylvaleronitrile), 2,2′-azobis(2-methylbutyronitrile), 2,2′-azobis(2,4,4-trimethylpentane), 2,2′-azobis(N-butyl-2-methylpropionamide), 2,2′-azobis {2-methyl-N-[2-(1-hydroxyethyl)]propionamide}, 2,2′-azobis {2-methyl-N-[2-(1-hydroxybutyl)]propionamide}, etc.; peroxide polymerization initiators such as lauroyl peroxide, t-butyl peroxy-2-ethylhexanoate, t-hexyl peroxy-2-ethylhexanoate, etc. The melting point of the polymerization initiator is not particularly limited, but may be lower than 100° C. since the polymerization is carried out by aqueous polymerization. Among known polymerization initiators, an azo polymerization initiator is preferable from the viewpoint of improving the thermal stability of the methacrylic resin to be obtained.

It is known that free radicals generated from a polymerization initiator cause, in addition to an addition reaction to a monomer, a hydrogen abstraction reaction in the presence of a substance that easily gives hydrogen. In this regard, the azo polymerization initiator generates only alkyl radicals, and thus has lower hydrogen abstraction ability than peroxide polymerization initiators. Here, if the polymerization initiator has high hydrogen abstraction ability, for example, in a case where methyl methacrylate is used as the monomer, hydrogen is abstracted from the x-methyl group of the methyl methacrylate or the methyl group of the ester by free radicals generated from the polymerization initiator, and polymerization proceeds from radicals newly generated on the x-methyl group or methyl group of the ester. As a result, a polymer in which double bonds derived from the monomer structure remain at its terminal is easily formed. Therefore, when a polymerization initiator having a high hydrogen abstraction ability is used, the thermal stability of the methacrylic resin obtained tends to be insufficient. Thus, an azo polymerization initiator is more preferable than a peroxide polymerization initiator in order to obtain a methacrylic resin having high thermal stability.

The hydrogen abstraction ability of the polymerization initiator can be measured, for example, by a radical trapping method using an x-methylstyrene dimer (i.e., an α-methylstyrene dimer trapping method).

In addition, as a result of investigation by the present inventors using various polymerization initiators, it has been found that a methacrylic resin synthesized using a non-nitrile azo polymerization initiator has a thermally stable terminal structure introduced into the molecule as compared with a methacrylic resin synthesized using a polymerization initiator other than the non-nitrile azo polymerization initiator (for example, a nitrile azo polymerization initiator). Therefore, among the azo polymerization initiators, non-nitrile azo polymerization initiators are more preferable. Examples of the non-nitrile-based azo polymerization initiator include those represented by the above formula (2), and at least one selected from dimethyl 2,2′-azobis(isobutyrate) and 1,1′-azobis(cyclohexanecarboxylic acid methyl) ester is preferable from the viewpoints of half-life temperature, cost, and the like.

An amount of the polymerization initiator to be used may be 1 part by mass or less, 0.5 parts by mass or less, or 0.1 parts by mass or less with respect to 100 parts by mass of a total amount of the monomer mixture. The lower limit of the amount of the polymerization initiator to be used is not particularly limited, but may be 0.001 parts by mass or more with respect to 100 parts by mass of the total amount of the monomer mixture from the viewpoint of the polymerization rate.

Examples of the chain transfer agent include primary alkyl mercaptan-based chain transfer agents such as n-butyl mercaptan, n-octyl mercaptan, n-hexadecyl mercaptan, n-dodecyl mercaptan, n-tetradecyl mercaptan, etc.; secondary alkyl mercaptan-based chain transfer agents such as s-butyl mercaptan, s-dodecyl mercaptan, etc.; tertiary alkyl mercaptan-based chain transfer agents such as t-dodecyl mercaptan, t-tetradecyl mercaptan, etc.; thioglycolic acid esters such as 2-ethylhexyl thioglycolate, ethylene glycol dithioglycolate, trimethylolpropane tris(thioglycolate), pentaerythritol tetrakis (thioglycolate), etc.; thiophenol, tetraethylthiuram disulfide, pentanephenylethane, acrolein, methacrolein, allyl alcohol, carbon tetrachloride, ethylene bromide, styrene oligomers (such as x-methylstyrene dimer, etc.), terpinolene; and the like. These chain transfer agents may be used alone or in combination of two or more types thereof.

Among these chain transfer agents, alkyl mercaptan-based chain transfer agents and thioglycolic acid esters are preferable, n-octyl mercaptan and 2-ethylhexyl thioglycolate are more preferable as the alkyl mercaptan-based chain transfer agent and the thioglycolic acid ester, respectively, from the viewpoints of handling property, stability, thermal stability of the methacrylic resin to be obtained, and the like.

An amount of the chain transfer agent to be used may be 0.03 mol % or less, or 0.025 mol % or less, based on a total amount of the monomer mixture. The lower limit of the amount of the chain transfer agent to be used is not particularly limited, but may be 0.0015 mol % or more, or may be 0.005 mol % or more, with respect to the total amount of the monomer mixture.

In order to obtain a methacrylic resin having a large weight average molecular weight (Mw) and a small proportion of terminal double bonds, a ratio of a total molar amount of the chain transfer agent to a total molar amount of the polymerization initiator is set to 1.6 or less. A ratio of a total molar amount of the chain transfer agent to the total molar amount of the polymerization initiator may be 1.5 or less, or 1.0 or less. The lower limit of the ratio of the total molar amount of the chain transfer agent to the total molar amount of the polymerization initiator is not particularly limited, but is preferably, for example, 0.1 or more, and may be 0.3 or more.

A polymerization temperature during the synthesis of the methacrylic resin may be set to less than 100° C., 20° C. or more and less than 100° C., 30 to 98° C., 50 to 96° C., or 60 to 95° C., from the viewpoints of control of syndiotacticity of the methacrylic resin to be obtained and productivity. After main reaction is completed in the polymerization in the first stage, the temperature may be raised to a higher temperature than in the first stage to perform post-polymerization in order to reduce residual monomers.

Since polymerization is started with a small amount of polymerization initiator, the polymerization reaction may be performed by lowering an amount of dissolved oxygen. An amount of dissolved oxygen in the raw material for polymerization may be 10 ppm or less, 5 ppm or less, 4 ppm or less, or 2 ppm or less. By limiting the amount of dissolved oxygen to such a range, the polymerization reaction proceeds smoothly, and coloration of the molded article of the methacrylic resin tends to be suppressed. Examples of methods for removing oxygen dissolved in the raw material for polymerization include feeding an inert gas such as a nitrogen gas continuously into the reaction vessel before, during, and after temperature rise to a predetermined polymerization temperature. In order to also remove dissolved oxygen from raw materials to be added during polymerization, it is preferable to independently supply an inert gas to the raw materials.

When a polymerization inhibitor is contained in the monomer mixture, the polymerization inhibitor may be removed by distillation or alkali extraction, or by using an adsorbent such as alumina, silica gel, molecular sieves, activated carbon, an ion exchange resin, zeolite, or acidic clay, in order to allow the polymerization reaction to proceed smoothly.

A suspension containing the methacrylic resin obtained by the suspension polymerization may be subjected to a washing operation such as acid washing, water washing, or alkali washing in order to remove the dispersant. The number of times of performing these washing operations may be selected from an optimum number of times in consideration of the working efficiency and the removal efficiency of the dispersant, and may be once or a plurality of times.

As a method of separating the methacrylic resin from the suspension containing the methacrylic resin, a conventionally known dehydration method can be employed. Examples of the dehydration method include a method using a centrifugal separator and a method of removing water by suction on a porous belt or a filtration membrane.

The methacrylic resin in a water-containing state obtained through the above dehydration can be recovered by performing a drying treatment by a conventionally known method. Examples of drying methods include: hot air drying in which drying is performed by sending hot air into a tank from a hot air blower, a blow heater, or the like; vacuum drying in which inside of a system is depressurized and heated as necessary to perform drying; barrel drying in which water is blown off by rotating the methacrylic resin obtained in a container; spin drying using centrifugal force; and the like. These drying methods may be carried out alone or in combination of two or more.

### [Emulsion Polymerization Method]

In the emulsion polymerization method, a methacrylic resin is synthesized in an emulsion in which water, a monomer mixture, an emulsifier, a polymerization initiator, a chain transfer agent, and optionally other additives are mixed.

As the monomer mixture, a monomer mixture in which a content of methyl methacrylate is 98% by mass or more, 99% by mass or more, or 100% by mass may be used.

Examples of the emulsifier include anionic surfactants such as alkylsulfonates, alkylbenzenesulfonates, dialkylsulfosuccinates, α-olefinsulfonates, naphthalenesulfonate-formaldehyde condensates, alkylnaphthalenesulfonates, N-methyl-N-acyltaurates, phosphate ester salts (polyoxyethylene alkyl ether phosphates, etc.), etc.; nonionic surfactants; and the like. Examples of salts described above include lithium salts, sodium salts, potassium salts, calcium salts, magnesium salts, etc. These emulsifiers may be used alone or in combination of two or more types thereof. The emulsifier used in the emulsion polymerization may remain in the final methacrylic resin.

When the pH of the emulsion deviates from neutral and becomes acidic or basic, an appropriate pH adjuster can be used in order to prevent hydrolysis of methyl methacrylate as a monomer or a structural unit derived from methyl methacrylate in a methacrylic resin to be obtained by polymerization. Examples of the pH adjuster to be used include boric acid-potassium chloride-potassium hydroxide, potassium dihydrogen phosphate-sodium hydrogen phosphate, boric acid-potassium chloride-potassium carbonate, citric acid-potassium hydrogen citrate, potassium dihydrogen phosphate-boric acid, sodium hydrogen phosphate-citric acid, etc.

Examples of the polymerization initiator and the chain transfer agent include the same polymerization initiators and chain transfer agents in the suspension polymerization method described above. The polymerization initiator may be built as a redox system where necessary.

In order to obtain a methacrylic resin having a high weight average molecular weight (Mw) and a small proportion of terminal double bonds, a ratio of a total molar amount of the chain transfer agent to a total molar amount of the polymerization initiator is set to 1.6 or less. The ratio of the total molar amount of the chain transfer agent to the total molar amount of the polymerization initiator may be 1.5 or less, or 1.0 or less. The lower limit of the ratio of the total molar amount of the chain transfer agent to the total molar amount of the polymerization initiator is not particularly limited, but is preferably, for example, 0.1 or more, and may be 0.3 or more.

A solid or powdery methacrylic resin can be obtained by subjecting latex of the methacrylic resin obtained by the emulsion polymerization to heat drying or spray drying, or by subjecting the latex to a known method such as adding a water-soluble electrolyte such as a salt or an acid to coagulate the latex, and further performing heat treatment, and then separating the resin component from the aqueous phase to perform drying. The salt is not particularly limited, but may be a divalent salt, and specifically, a calcium salt such as calcium chloride, calcium acetate, etc.; a magnesium salt such as magnesium chloride, magnesium sulfate, etc.; and the like. Among these salts, magnesium salts such as magnesium chloride, magnesium sulfate, etc. are preferable. During coagulation, additives generally added, such as an anti-aging agent, an ultraviolet absorber, etc., may be added.

Before the coagulation operation described above, the latex may be filtered through a filter, a mesh, or the like to remove fine polymerization scales. This can reduce fish eyes, foreign matters, etc. caused by the fine polymerization scales, when the methacrylic resin is formed into a molded article.

In one or more embodiments, the methacrylic resin to be obtained by the aqueous polymerization may be in the form of powder, grains, or grainy powder containing both powder and grains. With regard to primary particles constituting powder, grains, and grainy powder, the suspension polymerization is suitable for preparing primary particles having an average particle diameter of about 10 to 1,000 μm, and the emulsion polymerization is suitable for preparing primary particles having an average particle diameter of about 50 to 500 nm. The powder, the grains, and the grainy powder may contain an aggregate, which is an aggregate of primary particles.

After completion of the polymerization, the methacrylic resin may be purified as necessary. As a purification method, for example, a method in which a methacrylic resin is dissolved in a solvent and a solution obtained is added dropwise to a poor solvent to cause precipitation, a method of volatilizing and removing impurities by heating the methacrylic resin, or other methods. These methods are appropriately selected according to the application, and may be combined with each other.

### <Resin Composition>

The resin composition according to one or more embodiments includes the methacrylic resin according to the embodiment described above.

In addition, the resin composition according to one or more embodiments includes multilayer structure polymer particles from the viewpoint of further improving the thermal stability and mechanical properties of the molded article to be obtained. The multilayer structure polymer particles are not particularly limited, and known multilayer structure polymer particles can be appropriately used.

In a case where the resin composition according to one or more embodiments includes the multilayer structure polymer particles, blending proportions of the methacrylic resin and the multilayer structure polymer particles vary depending on the use or the like of the molded article, but a blending amount of the methacrylic resin is 30 to 98 parts by mass and a blending amount of the multilayer structure polymer particles is 2 to 70 parts by mass with respect to 100 parts by mass of a total blending amount of both components.

The resin composition according to one or more embodiments may further contain known additives such as a light stabilizer, an ultraviolet absorber, a heat stabilizer, a matting agent, a light diffusing agent, a coloring agent, a dye, a pigment, an antistatic agent, a thermal radiation reflecting material, a lubricant, a plasticizer, a stabilizer, a flame retardant, a mold release agent, a polymer processing aid, a filler, etc. and a resin other than the methacrylic resin. Examples of the resin other than the methacrylic resin include styrene-based resins such as an acrylonitrile styrene resin, a styrene maleic anhydride resin, etc.; a polycarbonate resin; a polyvinyl acetal resin; a cellulose acylate resin; fluororesins such as polyvinylidene fluoride, a polyfluoroalkyl (meth)acrylate resin, etc.; silicone-based resins; polyolefin-based resins; a polyethylene terephthalate resin; a polybutylene terephthalate resin; and the like.

In addition, in order to adjust orientation birefringence of the molded article, the resin composition according to one or more embodiments may include inorganic fine particles having birefringence described in Japanese Patent No. 3648201, Japanese Patent No. 4336586, or the like, and/or a low molecular weight compound having a molecular weight of 5,000 or less (or 1,000 or less) having birefringence described in Japanese Patent No. 3696649.

A form of the resin composition according to one or more embodiments is not particularly limited, and the resin composition may be in the form of powder, may be in the form of grains, may be in the form of grainy powder containing both powder and grains, or may be in the form of pellets.

### <Dope>

The dope according to one or more embodiments contains the methacrylic resin according to one or more embodiments described above and a solvent, and is used for producing a resin film by the solution casting method. The solvent includes a first solvent having a hydrogen bond term OH of 1 to 12 in Hansen solubility parameters and a second solvent having a hydrogen bond term OH of 14 to 24 in Hansen solubility parameters. The dope according to one or more embodiments may further contain other components such as multilayer structure polymer particles, similarly to the resin composition according to one or more embodiments described above. The components such as the methacrylic resin and the multilayer structure polymer particles are dissolved or dispersed in the solvent.

Examples of the first solvent having a hydrogen bond term CH of 1 to 12 include 1,4-dioxane (9.0), 2-phenylethanol (11.2), acetone (7.0), acetonitrile (6.1), chloroform (5.7), dibasic acid ester (8.4), diacetone alcohol (10.8), and N, N-dimethylformamide (11.3), dimethylsulfoxide (10.2), ethyl acetate (7.2), γ-butyrolactone (7.4), methyl ethyl ketone (5.1), methyl isobutyl ketone (4.1), methylene chloride (7.1), n-butyl acetate (6.3), N-methyl-2-pyrrolidone (7.2), propylene carbonate (4.1), 1,1,2,2-tetrachloroethane (5.3), tetrahydrofuran (8.0), toluene (2.0), etc. The numbers in parentheses indicate the value of the hydrogen bonding term H. These first solvents may be used alone or in combination of two or more types thereof. Among these first solvents, methyl ethyl ketone, chloroform, and methylene chloride are preferable, and methylene chloride is more preferable from the viewpoint of excellent solubility of the methacrylic resin and high volatilization rate.

Examples of the second solvent having a hydrogen bond term OH of 14 to 24 include methanol (22.3), ethanol (19.4), isopropanol (16.4), butanol (15.8), ethylene glycol monoethyl ether (14.3), etc. The numbers in parentheses indicate the value of the hydrogen bonding term δH. These second solvents may be used alone or in combination of two or more types thereof. Among these second solvents, methanol and ethanol are preferable, and ethanol is more preferable.

A proportion of the first solvent contained in the solvent may be 55% to 95% by mass, 60% to 95% by mass, or 70% to 95% by mass.

A content of the methacrylic resin in the dope according to one or more embodiments is not particularly limited, and is appropriately determined in consideration of solubility of the methacrylic resin in the solvent used, conditions for carrying out the solution casting method, and the like. The content of the methacrylic resin may be 5% to 50% by mass, 10% to 45% by mass, or 15% to 40% by mass.

A viscosity of the dope according to one or more embodiments can be appropriately adjusted by adjusting the content of the methacrylic resin and other components in the dope. From the viewpoints of coatability, filtration accuracy, and the like, the viscosity of the dope may be 1,000 poise (=100 Pa·s) or less, 500 poise (=50 Pa·s) or less, or 300 poise (=30 Pa·s) or less. The viscosity of the dope is measured by the method described in the Examples below.

The dope according to one or more embodiments is used for producing a resin film by the solution casting method. When producing a resin film by the solution casting method, first, the dope according to one or more embodiments is cast on the surface of a support, and is applied into a uniform film shape by an applicator to form a dope film. Alternatively, a pressure die may be used to cast the dope onto a support. Then, the formed dope film is heated on the support to evaporate the solvent, thereby forming a resin film. Conditions for evaporating the solvent can be appropriately determined according to the boiling point of the solvent to be used. Then, the formed resin film is peeled off from the surface of the support. Note that the resin film obtained may be appropriately subjected to a drying step, a heating step, a stretching step, or the like.

### <Resin Film>

The resin film according to one or more embodiments includes the methacrylic resin according to one or more embodiments described above. The resin film according to one or more embodiments is produced by the solution casting method, using, for example, the dope according to one or more embodiments described above.

The thickness of the resin film according to one or more embodiments is, for example, 500 μm or less, 300 μm or less, or 200 μm or less. The thickness of the resin film according to one or more embodiments is, for example, 10 μm or more, 30 μm or more, 50 μm or more, or 60 μm or more. The resin film having a thickness within the above range is advantageous in that the resin film is less likely to deform when vacuum molding is performed using the resin film, and breakage is less likely to occur in a deep drawn portion. Further, the resin film is also advantageous in that a resin film having uniform optical properties and excellent transparency can be manufactured.

A total light transmittance of the resin film according to one or more embodiments is 85% or more, 88% or more, or 90% or more. When the total light transmittance is in the above range, transparency is high, and thus the film can be suitably used for optical applications requiring light transmittability.

A glass transition temperature of the resin film according to one or more embodiments is 110° C. or higher, 115° C. or higher, 120° C. or higher, or 124° C. or higher. When the glass transition temperature is within the above range, heat resistance of the resin film becomes sufficient.

Haze of the resin film according to one or more embodiments is 2.0% or less, 1.5% or less, 1.3% or less, or 1.0% or less. Internal haze of the resin film may be 1.5% or less, 1.0% or less, 0.5% or less, or 0.4% or less. When the haze and the internal haze are within the above ranges, transparency is high, and thus the film can be suitably used for optical applications requiring light transmittability. Note that the haze is composed of haze inside a film and haze on a film surface (external), each haze being denoted as internal haze and external haze, respectively.

YI (Yellow Index) of the resin film according to one or more embodiments is 1.2 or less, or 1.0 or less. When YI is in the above range, transparency is high, and therefore, the composition can be suitably used for optical applications requiring light transmittability.

The resin film according to one or more embodiments has excellent mechanical properties, for example, high folding endurance. As a method of evaluating folding endurance, an MIT folding endurance test or a clamshell-type folding test is known. In the resin film according to one or more embodiments, for example, the number of folds until break in the clamshell-type folding test is 6,000 times or more, or 10,000 times or more. When the number of folds until break is within the above range, the folding endurance of the resin film is sufficient. Note that the number of folds until break in the clamshell-type folding test is measured by a method described in the Examples below.

The resin film according to one or more embodiments can be suitably used as an optical film such as a polarizer protective film, etc. When the resin film according to one or more embodiments is used as the polarizer protective film, it is preferable that optical anisotropy is small. In particular, not only the optical anisotropy in the in-plane direction (length direction or width direction) of the resin film but also optical anisotropy in the thickness direction may be small. That is, it is preferable that absolute values of in-plane retardation and thickness direction retardation are both small. For example, when a measurement wavelength is 590 nm, an absolute value of the in-plane retardation may be 20 nm or less, or 15 nm or less. An absolute value of the thickness direction retardation may be 50 nm or less, 20 nm or less, or 15 nm or less.

The retardation is an index value calculated based on birefringence. The in-plane retardation (Re) and the thickness direction retardation (Rth) can be calculated by the respective equations below. In an ideal resin film that is perfectly optically isotropic in the three-dimensional direction, both the in-plane retardation Re and the thickness direction retardation Rth are 0.

$$\begin{matrix}R e = ( nx - ny ) \times d \\ Rth = [ ( n x + ny ) / 2 - nz ] \times d\end{matrix}$$

In the above formula, nx, ny, and nz represent refractive indexes in respective axial directions, provided that an in-plane stretching direction (orientation direction of the polymer chain) is defined as X axis, a direction perpendicular to the X axis is defined as Y axis, and a thickness direction of the resin film is defined as Z axis. In addition, d represents the thickness of the resin film, and nx-ny represents orientation birefringence. A MD direction of the film is defined as the X-axis, but in the case of a stretched film, the stretching direction is defined as the X-axis.

In the resin film according to one or more embodiments, the value of orientation birefringence is −5.0×10⁻⁴ to 5.0×10⁻⁴, −4.0×10⁻⁴ to 4.0×10⁻⁴, or −3.8×10⁻⁴ to 3.8×10⁻⁴. When the orientation birefringence is in the above range, there is a tendency that stable optical characteristics can be obtained without causing birefringence during molding.

### (Stretching)

The resin film according to one or more embodiments may be further stretched. By stretching the resin film, it is possible to improve mechanical strength and film thickness accuracy of the resin film.

When the resin film according to one or more embodiments is stretched, a resin film in an unstretched state is once molded from the dope according to one or more embodiments, and then uniaxial stretching or biaxial stretching is performed. Alternatively, during the molding of the resin film, a stretching operation is appropriately performed along with the progress of the steps of film formation and degassing of the solvent. Thereby, a stretched film (uniaxially stretched film or biaxially stretched film) can be produced. Stretching during film molding and stretching after film molding may be appropriately combined.

A stretching ratio of the stretched film is not particularly limited, and is appropriately determined according to the mechanical strength, surface properties, thickness accuracy, and the like of the stretched film to be produced. Although it also depends on the stretching temperature, the stretching ratio may be generally selected in the range of 1.1 to 5 times, in the range of 1.3 to 4 times, or in the range of 1.5 to 3 times. Within the stretching ratio in the range described above, mechanical properties of the film such as elongation, tear propagation strength, and kneading resistance of the film tend to be significantly improved.

### (Applications)

The resin film according to one or more embodiments can be used for various applications such as transportation equipment, solar cell members, civil engineering building members, daily goods, electric and electronic devices, optical members, and medical products. In particular, since the resin film according to one or more embodiments has excellent heat resistance and optical properties, it can be suitably used for optical applications. Examples of optical applications include a front plate (cover window) of various display devices, a diffusion plate, a polarizer protective film, a polarizing plate protective film, a retardation film, a light diffusion film, and an optical isotropic film.

Among these, the resin film according to one or more embodiments can be suitably used as a polarizer protective film or a front plate (cover window) of a display device. When the resin film according to one or more embodiments is used as a front plate (cover window) of various display devices, a functional coating layer such as a primer layer or a hard coat layer may be formed on at least one main surface of the resin film as necessary. When the resin film according to one or more embodiments is used as a polarizer protective film, the resin film according to one or more embodiments is bonded to a polarizer to form a polarizing plate. The polarizer is not particularly limited, and any conventionally known polarizer can be used. The polarizing plate is used, for example, in a display device such as a liquid crystal display device, an organic EL display device, etc.

### EXAMPLES

Hereinafter, one or more embodiments of the present invention will be described more specifically based on Examples and Comparative Examples, but one or more embodiments of the present invention are not limited to the following Examples. The measurement methods of various physical properties described in Examples and Comparative Examples are as follows.

### (1) Polymerization Conversion Ratio

The polymerization conversion ratio of the methacrylic resin was determined from a ratio of a weight of a methacrylic resin obtained by washing with water, followed by drying, with respect to a weight of monomers used. As for a weight of the methacrylic resin obtained by washing with water, followed by drying, a value obtained by subtracting a weight of remaining monomers in the methacrylic resin obtained by the following analysis was used.

### Analysis Conditions of Examples 1 and 2

A ¹H-NMR spectrum of a methacrylic resin was measured in a deuterated chloroform solution at 22° C. for 16 integrations using a nuclear magnetic resonance apparatus (AVANCEIII 400 MHz, manufactured by Bruker). From the spectrum, an area (Y) of a methoxy group-derived peak (3.60 ppm) and the sum (X) of areas of the remaining monomer peaks (if the monomer is methyl methacrylate, 6.11 ppm and 5.56 ppm) were calculated, provided that tetramethylsilane (TMS) was 0 ppm. After a proportion of the remaining monomers was obtained from formula [(3×X)/(2×Y)]×100, the value was plugged into a correlation formula prepared in advance between the proportion of the remaining monomers calculated by 1H-NMR and an amount of the remaining monomers obtained by gas chromatograph analysis. The polymerization conversion ratio was calculated using the remaining amount of the monomers in the methacrylic resin obtained.

### Analysis Conditions of Examples 3 to 7, Comparative Example 2, and Comparative Example 3

Using a gas chromatograph (7890B manufactured by Agilent Technologies) and DB-1 (film thickness 0.8 μm×inner diameter 0.20 mm×length 30 m manufactured by Agilent Technologies) as an analytical column, analysis was carried out at an inlet temperature of 150° C. and a detector temperature of 320° C. The column temperature was set to the following conditions: the column temperature was raised from 35° C. to 210° C. at a temperature rising rate of 30° C./min, then raised from 210° C. to 260° C. at a temperature rising rate of 10° C./min, further raised from 260° C. to 320° C. at a temperature rising rate of 20° C./min, and held for 3 minutes. A calibration curve was prepared according to an internal reference method using chlorobenzene as an internal reference substance. Remaining amount of monomers in the methacrylic resin was calculated, and then the polymerization conversion ratio was calculated.

### (2) Chain Transfer Agent Residual Proportion

The chain transfer agent residual proportion in the methacrylic resin was quantified using a gas chromatograph (7890B, manufactured by Agilent Technologies). As the analytical column, DB-1 (film thickness 0.8 μm×inner diameter 0.20 mm×length 30 m manufactured by Agilent Technology Inc.) was used, and the inlet temperature and the detector temperature were set to 150° C. and 320° C., respectively. The column temperature was set to the following conditions: the column temperature was raised from 35° C. to 210° C. at a temperature rising rate of 30° C./min, then raised from 210° C. to 260° C. at a temperature rising rate of 10° C./min, further raised from 260° C. to 320° C. at a temperature rising rate of 20° C./min, and held for 3 minutes. A calibration curve was prepared according to an internal reference method using dichloromethane as a measurement solvent and chlorobenzene as an internal reference substance. The chain transfer agent residual proportion in the methacrylic resin was calculated.

### (3) Triad Syndiotacticity (rr)

A 1H-NMR spectrum of a methacrylic resin was measured in a deuterated chloroform solution at 22° C. for 16 integrations using a nuclear magnetic resonance apparatus (AVANCE III 400 MHz manufactured by Bruker). From the spectrum, an area (X) of a region of 0.60 to 0.95 ppm and an area (Y) of a region of 0.60 to 1.25 ppm were measured, provided that tetramethylsilane (TMS) is assigned as 0 ppm, and then triad syndiotacticity (rr) was calculated, using the formula: (X/Y)×100.

### (4) Weight Average Molecular Weight (Mw), and Ratio of Weight Average Molecular Weight (Mw) and Number Average Molecular Weight (Mn)

A weight average molecular weight (Mw), a number average molecular weight (Mn), and a ratio of the weight average molecular weight (Mw) and the number average molecular weight (Mn) of the methacrylic resin were calculated by a standard polystyrene conversion method using gel permeation chromatography (GPC). Specifically, analysis was carried out on the following apparatus under the following conditions, using a sample solution prepared by dissolving 20 mg of a methacrylic resin in 10 mL of tetrahydrofuran.
Measuring instrument: HLC-8220 GPC (Tosoh)
Detector: RI detector
Solvent: tetrahydrofuran
Guard column: TSKgel guard column SuperHZ-H (Tosoh)
Analytical column: TSKgel SuperHZM-H×2 (Tosoh)
Measurement temperature: 40° C.
Standard material: standard polystyrene (Tosoh)

### (5) Proportion of Terminal Double Bonds

A solution was prepared by dissolving about 20 mg of a methacrylic resin in 0.6 to 0.7 mL of deuterated chloroform, and 1H-NMR measurement was performed using a nuclear magnetic resonance apparatus (AVANCE NEO 700 MHZ manufactured by Bruker). The measurement temperature and the number of times of integration were set to 20° C. and 8, 192 times, respectively, and the measurement was performed while erasing a methoxy group-derived peak (3.60 ppm, which is a value when the chemical shift of the solvent was assumed to be 7.26 ppm) of the methacrylic resin by using Excitation Sculpting (ES) method, which is a type of solvent erasing methods. From the obtained ¹H-NMR spectrum, a total area (X) of peaks (5.47 to 5.52 ppm and 6.21 ppm) derived from the terminal double bond portion of the methacrylic resin and an area (Y) of peaks (0.5 to 1.25 ppm) derived from the α-methyl group of the methacrylic resin were determined, and then the proportion of terminal double bonds of the methacrylic resin was calculated by the formula: [(3×X)/(2×Y)×100.

### (6) Glass Transition Temperature (Tg)

The glass transition temperature (Tg) of the methacrylic resin and the resin film before stretching was measured using a differential scanning calorimeter (DSC; DSC7000X manufactured by Hitachi High-Tech Science). First, DSC measurement was carried out under the conditions that a first temperature rise was carried out from 40° C. to 160° C. at a temperature rising rate of 10° C./min under a nitrogen flow rate of 40 mL/min, and after cooling to 40° C., a second temperature rise was carried out from 40° C. to 160° C. at a temperature rising rate of 10° C./min. Then, midpoint glass transition temperature was read from the DSC curve measured during the second temperature rise (the midpoint glass transition temperature is a temperature of a point at which a straight line equidistant in the vertical axis direction from both a straight line obtained by extrapolating the baseline before the inflection point to the high temperature side and a straight line obtained by extrapolating the baseline after the inflection point to the low temperature side intersects the curve of the stepwise change portion of the glass transition).

### (7) 5% Weight Loss Temperature (Td5)

The 5% weight loss temperature (Td5) of the methacrylic resin was measured using a thermogravimetric analyzer (STA7200 manufactured by Hitachi High-Tech Sciences, Inc.). A first temperature rise was carried out from 40° C. to 190° C. at a temperature rising rate of 10° C./min under a nitrogen flow of 200 mL/min to remove moisture and the like absorbed by the methacrylic resin, and after cooling to 40° C., a second temperature rise was carried out from 40° C. to 500° C. at a temperature rising rate of 10° C./min. A temperature at which the weight of the sample was reduced to 95%, which was determined from a thermogravimetric (TG) curve measured during the second temperature rise, was defined as a 5% weight loss temperature (Td5).

### (8) Dope Viscosity

A methacrylic resin was dissolved in a mixed solvent composed of 93% by mass of methylene chloride and 7% by mass of ethanol to prepare a dope having a solid concentration (SC) of 10% by mass (Examples 1 and 2), 12% by mass (Example 3), or 25% by mass (Comparative Examples 1 and 2). The dope viscosity was measured using a B-type viscometer (BMII manufactured by TOKI SANGYO). The temperature of the measurement sample was adjusted to 23° C., and a value indicated at 30 rpm (12 rpm in Examples 1 and 3) was read using a No. 2 rotor.

### (9) Haze Measurement

Haze of the stretched resin film was measured using a haze meter (HZ-V3 manufactured by Suga Test Instruments) in accordance with JIS K7136. Further, both surfaces of the resin film were sandwiched by glycerin and then glass in this order, and a value obtained by performing the same measurement was defined as an internal haze. The result obtained was converted to a film thickness equivalent to 40 μm.

### (10) Total Light Transmission

A total light transmittance of the stretched resin film was measured using a haze meter (HZ-V3 manufactured by Suga Test Instruments) in accordance with JIS K7361-1.

### (11) YI

YI of the stretched resin film was measured using a spectrophotometer (SC-P manufactured by Suga Test Instruments) in accordance with JIS K7373. The result obtained was converted to a film thickness equivalent to 40 μm.

### (12) Clamshell-Type Folding Test

The folding endurance of a stretched methacrylic resin was evaluated using a clamshell-type desktop endurance tester (DMLHP-CS manufactured by YUASA SYSTEM Co., Ltd.). Under an atmosphere of 23° C. and a relative humidity of 55%, the tester was set to conditions of a radius of curvature of 0.35 mm and a test speed of 30 r/min (30 times/min). A film cut out into a strip shape having a width of 2 cm×a length of 5 cm was used as a test piece, and the test was carried out, by setting the test piece in a direction where a fold is formed in a direction perpendicular to the stretching direction. The test was continued until the specimen broke. The test was performed three times for each sample, and the folding endurance was evaluated based on the number of folds until break.

### Example 1

170 parts by mass of deionized water, 0.10 parts by mass of disodium hydrogen phosphate as a suspension aid, and 0.037 parts by mass of dimethyl 2,2′-azobis(isobutyrate) (V-601 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.017 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 77° C. to start polymerization. The monomer was allowed to react at 77° C. for 4 hours, and then the temperature of the liquid in the reactor was raised to 95° C. The reaction mixture was stirred at the same temperature for 1 hour to terminate the polymerization. The resin obtained was washed with deionized water in an amount of 4.6 times the amount of the resin obtained, followed by drying to obtain resin particles in the form of beads. These particles were dissolved in methylene chloride to a concentration of 10% by mass, and the solution was added dropwise to methanol in 5 times the volume of methylene chloride solution to precipitate the resin. The precipitated resin was collected by suction filtration and dried to obtain a methacrylic resin after precipitation purification.

A mixed solvent of 93% by mass of methylene chloride and 7% by mass of ethanol was placed in a screw tube container, and then the methacrylic resin after drying was added. The solution was stirred until the methacrylic resin completely dissolved to prepare a dope having a solid concentration (SC) of 10% by mass.

The above-prepared dope was cast on a PET film substrate (Cosmoshine A4100 manufactured by Toyobo Co., Ltd.) and applied by an applicator so as to be a uniform film. At this time, the clearance was adjusted so that the thickness after drying was about 60 μm. After the application, the dope film was dried in an oven at 40° C. for 1 hour, and then the resin film obtained was peeled off from the PET film substrate. Thereafter, the resin film was fixed to a stainless-steel frame and dried in an oven at 140° C. for 2 hours to remove the remaining solvent, thereby obtaining a resin film. Further, the resin film obtained was subjected to width-fixed uniaxial stretching at 135° C. The stretching ratio was 1.5 times, and the stretching speed was 100 mm/min. The average film thickness of the stretched resin film was 43 μm.

The physical properties of the methacrylic resin, the dope, and the resin film in Example 1 are shown in Table 1. Note that in Table 1, blanks in the raw material column of the methacrylic resin indicate that the raw material was not used.

### Example 2

The same operation as in Example 1 was carried out except that the amount of n-octylmercaptan (n-OM) to be used was changed to 0.036 parts by mass, and the amount of deionized water with which the obtained resin was washed was changed to 4.3 times the amount of the resin. The average film thickness of the resulting stretched resin film was 41 μm. The physical properties of the methacrylic resin, the dope, and the resin film in Example 2 are shown in Table 1.

### Example 3

150 parts by mass of deionized water, 0.400 parts by mass of calcium triphosphate as the dispersant, 0.0075 parts by mass of sodium α-olefinsulfonate, and 0.30 parts by mass of sodium chloride were charged into a 4-liter glass reactor equipped with an H-type stirring blade type stirrer. While stirring the aqueous solution in the reactor at 250 rpm, a nitrogen gas (oxygen concentration: 0.2 ppm) was bubbled to replace the air in the reactor, and then a monomer solution containing 100 parts by mass of methyl methacrylate (MMA), 0.017 parts by mass of n-octylmercaptan (n-OM) as the chain transfer agent, and 0.037 parts by mass of dimethyl 2,2′-azobis(isobutyrate) (V-601 manufactured by Fujifilm Wako Pure Chemical) as the polymerization initiator was added to the reactor. Thereafter, the temperature of the liquid in the reactor was raised to 80° C. to start polymerization. At 45 minutes from the start of polymerization, 0.10 parts by mass of additional calcium triphosphate was added to the reaction solution. At 2 hours from the start of polymerization, the temperature of the liquid in the reactor was raised to 95° C., and stirring was continued at 95° C. for 1 hour, at which point the polymerization was terminated. Acid washing was performed twice using a 1 N hydrochloric acid solution in an amount of 0.1 times in terms of weight ratio, with respect to the amount of the monomer charged, followed by washing with water and drying to obtain resin particles in the form of beads. These particles were dissolved in methylene chloride so as to have a concentration of 7% by mass, the obtained methylene chloride solution was filtered using a pressure filter equipped with a 5 μm filter, and the filtrate containing the resin was dried in an oven at 70° C. for 12 hours and at 140° C. for 2 hours. The resin obtained after drying was immersed in methanol at a weight ratio of 2.5 times that of the resin, and allowed to stand at room temperature for 12 hours and at 50° C. for 5 hours. The resin was collected by suction filtration and dried in an oven at 70° C. for 12 hours and at 140° C. for 5 hours. Further, the resin was vacuum dried at 140° C. for 2 hours to obtain a purified methacrylic resin.

A mixed solvent of 93% by mass of methylene chloride and 7% by mass of ethanol was placed in a screw tube container, and then the methacrylic resin after drying was added. The solution was stirred until the methacrylic resin completely dissolved to prepare a dope having a solid concentration (SC) of 12% by mass.

The above-prepared dope was cast on a PET film substrate (Cosmoshine A4100 manufactured by Toyobo Co., Ltd.) and applied by an applicator so as to be a uniform film. At this time, the clearance was adjusted so that the thickness after drying was about 60 μm. After the application, the dope film was dried in an oven at 40° C. for 1 hour, and then the resin film obtained was peeled off from the PET film substrate. Thereafter, the resin film was fixed to a stainless-steel frame and dried in an oven at 140° C. for 2 hours to remove the remaining solvent, thereby obtaining a resin film. Further, the resin film obtained was subjected to width-fixed uniaxial stretching at 132° C. The stretching ratio and the stretching speed were set to 1.5 times and 100 mm/min, respectively. The average film thickness of the stretched resin film was 41 μm.

The physical properties of the methacrylic resin, the dope, and the resin film in Example 3 are shown in Table 1.

### Example 4

150 parts by mass of deionized water, 0.400 parts by mass of calcium triphosphate as the dispersant, 0.0075 parts by mass of sodium α-olefinsulfonate, and 0.30 parts by mass of sodium chloride were charged into a 5-liter glass reactor equipped with an H-type stirring blade type stirrer. While stirring the aqueous solution in the reactor at 250 rpm, a nitrogen gas (oxygen concentration: 0.2 ppm) was bubbled to replace the air in the reactor, and then a monomer solution containing 100 parts by mass of methyl methacrylate (MMA), 0.017 parts by mass of n-octylmercaptan (n-OM) as the chain transfer agent, and 0.019 parts by mass of 2,2′-azobis(2,4-dimethylvarelonitrile) (V-65 manufactured by Fujifilm Wako Pure Chemical) as the polymerization initiator was added to the reactor. Thereafter, the temperature of the liquid in the reactor was raised to 75° C. to start polymerization. At 45 minutes from the start of polymerization, 0.10 parts by mass of additional calcium triphosphate was added to the reaction solution. At 4 hours from the start of polymerization, the temperature of the liquid in the reactor was raised to 95° C., and stirring was continued at 95° C. for 3 hours, at which point the polymerization was terminated. The polymerization conversion ratio at 4 hours after the polymerization start was 92%. Acid washing was performed once using a 1 N hydrochloric acid solution in an amount of 0.1 times in terms of weight ratio, with respect to the amount of the monomer charged. Water washing was carried out using deionized water in an amount of 7 times that of the resin, followed by drying the resin to obtain resin particles in the form of beads. These particles were dissolved in methylene chloride so as to have a concentration of 10% by mass, the obtained methylene chloride solution was added dropwise to methanol in 5 times volume of the methylene chloride solution to precipitate the resin. The resin precipitated was collected by suction filter, followed by drying, to obtain a methacrylic resin after precipitation purification.

A mixed solvent of 93% by mass of methylene chloride and 7% by mass of ethanol was placed in a screw tube container, and then the methacrylic resin after drying was added. The solution was stirred until the methacrylic resin completely dissolved to prepare a dope having a solid concentration (SC) of 12% by mass.

The above-prepared dope was cast on a PET film substrate (Cosmoshine A4100 manufactured by Toyobo Co., Ltd.) and applied by an applicator to be a uniform film. At this time, the clearance was adjusted so that the thickness after drying was about 60 μm. After the application, the dope film was dried in an oven at 40° C. for 1 hour, and then the obtained resin film was peeled off from the PET film substrate. Thereafter, the resin film was fixed to a stainless-steel frame and dried in an oven at 140° C. for 2 hours to remove the remaining solvent, thereby obtaining a resin film. Further, the resin film obtained was subjected to width-fixed uniaxial stretching at 132° C. The stretching ratio was 1.5 times, and the stretching speed was 100 mm/min. The average film thickness of the stretched resin film was 41 μm.

The physical properties of the methacrylic resin, the dope, and the resin film in Example 4 are shown in Table 2.

### Example 5

The same operation as in Example 4 was carried out except that the type of polymerization initiator was changed to t-butyl peroxy-2-ethylhexanoate (Perbutyl O manufactured by NOF). The polymerization conversion ratio at 4 hours from the start of polymerization was 90%. The average film thickness of the resulting stretched resin film was 43 μm. The physical properties of the methacrylic resin, the dope, and the resin film in Example 5 are shown in Table 2.

### Example 6

The same operation as in Example 4 was carried out except that the type of polymerization initiator was changed to t-hexyl peroxy-2-ethylhexanoate (Perhexyl O manufactured by NOF). The polymerization conversion ratio at 4 hours from the start of polymerization was 93%. The average film thickness of the resulting stretched resin film was 40 μm. The physical properties of the methacrylic resin, the dope, and the resin film in Example 6 are shown in Table 2.

### Example 7

A methacrylic resin was obtained by carrying out the same polymerization operation as in Example 4 and the same washing and drying as in Example 4, except that the type of the polymerization initiator was changed to t-hexyl peroxy-2-ethylhexanoate (Perhexyl O manufactured by NOF) and the amount of n-octylmercaptan (n-OM) added as the chain transfer agent was changed to 0.0025 parts by mass. The polymerization conversion ratio at 4 hours from the start of polymerization was 93%.

A mixed solvent of 93% by mass of methylene chloride and 7% by mass of ethanol was placed in a screw tube container, and then the methacrylic resin after drying was added. The solution was stirred until the methacrylic resin completely dissolved to prepare a dope having a solid concentration (SC) of 5% by mass. Using this dope, a resin film was produced in the same manner as in Example 4, and the average film thickness of the resulting stretched resin film was 41 μm. The physical properties of the methacrylic resin, the dope, and the resin film in Example 7 are shown in Table 2.

### Comparative Example 1

Parapet HR-S (A copolymer of methyl methacrylate (MMA) and methyl acrylate (MA) manufactured by Kuraray, MMA/MA=98.9/1.1 (mass ratio)) was used as the methacrylic resin, and precipitation purification from a methylene chloride solution of the methacrylic resin to methanol was not performed. However, the precipitation purification was performed only when preparing a sample for quantification of terminal double bonds. Using this methacrylic resin, the same operation as in Example 1 was carried out except that the solid concentration (SC) of the dope was changed to 25% by mass and the stretching temperature of the resin film was changed to 125° C. The average film thickness of the resulting stretched resin film was 36 μm. The physical properties of the methacrylic resin, the dope, and the resin film in Comparative Example 1 are shown in Table 3. In Table 3, blanks in the raw material column of the methacrylic resin indicate that the raw material was not used.

### Comparative Example 2

170 parts by mass of deionized water, 0.10 parts by mass of disodium hydrogen phosphate as the suspension aid, and 0.037 parts by mass of dimethyl 2,2′-azobis(isobutyrate) (V-601 manufactured by Fujifilm Wako Pure Chemical Corporation) as the polymerization initiator were added to a 2-liter glass reactor equipped with a three-way sweptback blade type stirrer. While stirring the aqueous solution in the reactor at 550 rpm, a nitrogen gas (oxygen concentration: 0.2 ppm) was bubbled to replace the air in the reactor, and then a monomer solution containing 100 parts by mass of methyl methacrylate (MMA) and 0.270 parts by mass of n-octylmercaptan (n-OM) as the chain transfer agent was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 79° C. to start polymerization. The monomer was allowed to react at 79° C. for 6 hours, and then the temperature of the liquid in the reactor was raised to 94° C. The reaction mixture was stirred at the same temperature for 1 hour to terminate the polymerization. The resin obtained was washed with deionized water in an amount of 3.4 times the amount of the resin obtained, followed by drying to obtain resin particles in the form of beads. These particles were dissolved in methylene chloride so as to have a concentration of 10% by mass, the obtained methylene chloride solution was added dropwise to methanol in a volume of 5 times the methylene chloride solution to precipitate the resin. The precipitated resin was collected by suction filtration and dried to obtain a methacrylic resin after precipitation purification.

A mixed solvent of 93% by mass of methylene chloride and 7% by mass of ethanol was placed in a screw tube container, and then the methacrylic resin after drying was added. The solution was stirred until the methacrylic resin completely dissolved to prepare a dope having a solid concentration (SC) of 25% by mass.

The above-prepared dope was cast on a PET film substrate (Cosmoshine A4100 manufactured by Toyobo Co., Ltd.) and applied by an applicator to be a uniform film. At this time, the clearance was adjusted so that the thickness after drying was about 40 μm. After the application, the dope film was dried in an oven at 40° C. for 1 hour, and then the obtained resin film was peeled off from the PET film substrate. Thereafter, the resin film was fixed to a stainless-steel frame and dried in an oven at 140° C. for 2 hours to remove the remaining solvent, thereby obtaining a resin film. Further, the obtained resin film was subjected to width-fixed uniaxial stretching at 132° C. The stretching ratio and the stretching speed were set to 1.5 times and 100 mm/min, respectively. The average film thickness of the stretched resin film was 38 μm.

The physical properties of the methacrylic resin, the dope, and the resin film in Comparative Example 2 are shown in Table 3.

### Comparative Example 3

170 parts by mass of deionized water, 0.10 parts by mass of sodium dihydrogen phosphate as a suspension aid, and 1.00 parts by mass of 2,2′-azobis(4-methoxy-2,4-dimethylvarelonitrile) (V-70 manufactured by Fujifilm Wako Pure Chemical Corporation) as the polymerization initiator were charged into a 0.5-liter glass reactor equipped with an H-type stirring blade type stirrer. While stirring the aqueous solution in the reactor at 380 rpm, a nitrogen gas (oxygen concentration: 0.2 ppm) was bubbled to replace the air in the reactor, and then a monomer solution containing 100 parts by mass of methyl methacrylate (MMA), was added to the reactor. Subsequently, 0.375 parts by mass of metolose 60SH-50 (hydroxypropyl methylcellulose manufactured by Shin-Etsu Chemical), which is a water-soluble polymer, was added as the dispersant to the reactor. After stirring for 30 minutes, the temperature of the liquid in the reactor was raised to 30° C. to start polymerization. The monomer was allowed to react at 30° C. for 3 hours, then the liquid in the reactor was heated to 50° C. and stirred for 1 hour, then heated to 70° C. and stirred for 30 minutes, further heated to 95° C. and stirred for 1 hour, at which point the polymerization was terminated. The resin obtained was washed with deionized water in an amount of 7 times the amount of the resin, followed by drying to obtain resin particles in the form of beads. These particles were dissolved in methylene chloride to a concentration of 10% by mass, and the solution was added dropwise to methanol in an amount of 5 times the amount of the methylene chloride solution to precipitate the resin. The precipitated resin was collected by suction filtration and dried to obtain a methacrylic resin after precipitation purification. The physical properties of the methacrylic resin in Comparative Example 3 are shown in Table 3.

TABLE 1

| | | | | Example | Example | Example |
|---|---|---|---|---|---|---|
| | Name | | Unit | 1 | 2 | 3 |
| Raw | Monomer | Methyl methacrylate | % by mass | 100 | 100 | 100 |
| material | | | mol % | 100 | 100 | 100 |
| for resin | Polymeri- | Dimethyl 2,2′ | % by mass | 0.037 | 0.037 | 0.037 |
| | zation | azobis (isobutyrate) | mol % | 0.016 | 0.016 | 0.016 |
| | initiator | 2,2′-azobis (2, 4- | % by mass | | | |
| | | dimethylvaleronitrile) | mol % | | | |
| | | t-butyl peroxy-2- | % by mass | | | |
| | | ethylhexanoate | mol % | | | |
| | | t-hexyl peroxy-2- | % by mass | | | |
| | | ethylhexanoate | mol % | | | |
| | Chain | n-octyl mercaptan | % by mass | 0.017 | 0.036 | 0.017 |
| | transfer | | mol % | 0.012 | 0.025 | 0.012 |
| | agent | | | | | |
| Ratio of | Chain transfer agent/ | | Molar | 0.7/1 | 1.5/1 | 0.7/1 |
| amounts of | polymerization initiator | | ratio | | | |
| raw | | | | | | |
| materials | | | | | | |
| used | | | | | | |
| Polymerization conversion | | | % | 96 | 96 | 90 |
| | | | | Example | Example | Example |
| Item | | | Unit | 1 | 2 | 3 |
| Physical | Mathacrylic | Chain transfer agent | % by mass | 0.0003 | 0.0008 | 0.0010 |
| properties | resin | residual proportion in the | | | | |
| | | methacrylic resin before | | | | |
| | | purification | | | | |
| | | Chain transfer agent | % by mass | Not | Not | Not |
| | | residual proportion in the | | detected | detected | detected |
| | | methacrylic resin after | | | | |
| | | purification | | | | |
| | | Syndiotacticity | % | 59 | 59 | 56 |
| | | Weight average molecular | — | 827,000 | 464,000 | 755,000 |
| | | weight (Mw) | | | | |
| | | Weight average molecular | — | 2.10 | 1.96 | 2.06 |
| | | weight (Mw)/ | | | | |
| | | Number average | | | | |
| | | molecular weight (Mn) | | | | |
| | | Proportion of terminal | mol % | 0.004 | 0.004 | 0.004 |
| | | double bonds | | | | |
| | | Glass transition | ° C. | 126 | 126 | 123 |
| | | temperature (Tg) | | | | |
| | | 5% weight loss | ° C. | 305 | 305 | 314 |
| | | temperature (Td5) | | | | |
| | Dope | Dope viscosity | Poise | 15 | 2.7 | 17 |
| | Resin film | Glass transition | ° C. | 125 | 125 | 124 |
| | (before | temperature (Tg) | | | | |
| | stretching) | | | | | |
| | Resin film | Haze | % | 0.51 | 0.77 | 0.27 |
| | (after | Internal haze | % | 0.03 | 0.04 | 0.12 |
| | stretching) | Total light transmittance | % | 92.5 | 92.3 | 92.5 |
| | | YI | — | 0.20 | 0.15 | 0.19 |
| | | Number of folds until | Number | >20,000 | 11,000- | >20,000 |
| | | break in clamshell-type | of folds | | 13,000 | |
| | | folding test | | | | |

TABLE 2

| | | | | Example | Example | Example | Example |
|---|---|---|---|---|---|---|---|
| | Name | | Unit | 4 | 5 | 6 | 7 |
| Raw | Monomer | Methyl methacrylate | % by mass | 100 | 100 | 100 | 100 |
| material | | | mol % | 100 | 100 | 100 | 100 |
| for resin | Polymeri- | Dimethyl 2,2′- | % by mass | | | | |
| | zation | azobis (isobutyrate) | mol % | | | | |
| | initiator | 2,2′-azobis (2,4- | % by mass | 0.019 | | | |
| | | dimethylvaleronitrile) | mol % | 0.0075 | | | |
| | | t-butyl peroxy-2- | % by mass | | 0.037 | | 0.019 |
| | | ethylhexanoate | mol % | | 0.017 | | 0.0086 |
| | | t-hexyl peroxy-2- | % by mass | | | 0.037 | |
| | | ethylhexanoate | mol % | | | 0.015 | |
| | Chain | n-octyl mercaptan | % by mass | 0.017 | 0.017 | 0.017 | 0.0025 |
| | transfer | | mol % | 0.012 | 0.012 | 0.012 | 0.0017 |
| | agent | | | | | | |
| Ratio of | Chain transfer agent/ | | Molar | 1.6/1 | 0.71/1 | 0.80/1 | 0.20/1 |
| amounts of | polymerization initiator | | ratio | | | | |
| materials | | | | | | | |
| used | | | | | | | |
| Polymerization conversion | | | % | — | — | — | — |
| | | | | Example | Example | Example | Example |
| | Item | | Unit | 4 | 5 | 6 | 7 |
| Physical | Methacrylic | Chain transfer agent | % by mass | — | — | — | — |
| properties | resin | residual proportion in the | | | | | |
| | | methacrylic resin before | | | | | |
| | | purification | | | | | |
| | | Chain transfer agent | % by mass | — | — | — | — |
| | | residual proportion in the | | | | | |
| | | methacrylic resin after | | | | | |
| | | purification | | | | | |
| | | Syndiotacticity | % | 58 | 59 | 59 | 59 |
| | | Weight average molecular | — | 1,030,000 | 1,397,000 | 923,000 | 3,934,000 |
| | | weight (Mw) | | | | | |
| | | Weight average molecular | — | 1.96 | 2.35 | 2.12 | 2.03 |
| | | weight (Mw)/Number average | | | | | |
| | | molecular weight (Mn) | | | | | |
| | | Proportion of terminal | mol % | 0.002 | 0.001 | 0.001 | 0.0005 |
| | | double bonds | | | | | |
| | | Glass transition | ° C. | 125 | 126 | 123 | 124 |
| | | temperature (Tg) | | | | | |
| | | 5% weight loss temperature | ° C. | 305 | 312 | 308 | 308 |
| | | (Td5) | | | | | |
| | Dope | Dope viscosity | Poise | — | — | — | — |
| | Resin film | Glass transition | ° C. | — | — | — | — |
| | (before | temperature (Tg) | | | | | |
| | stretching) | | | | | | |
| | Resin film | Haze | % | 0.96 | 1.04 | 0.95 | 1.39 |
| | (after | Internal haze | % | 0.63 | 0.66 | 0.73 | 0.71 |
| | stretching) | Total light transmittance | % | 92.4 | 92.5 | 92.5 | 92.3 |
| | | YI | — | 0.43 | 0.35 | 0.35 | 0.42 |
| | | Number of folds until | Number | >200,000 | >200,000 | >200,000 | >200,000 |
| | | break in clamshell-type | of folds | | | | |
| | | folding test | | | | | |

TABLE 3

| | | | | Comparative | Comparative | Comparative |
|---|---|---|---|---|---|---|
| | | | | Example | Example | Example |
| | Name | | Unit | 1 | 2 | 3 |
| Raw | Monomer | Methyl methacrylate | % by mass | 98.9 | 100 | 100 |
| material | | | mol % | 98.7 | 100 | 100 |
| for resin | | Methyl acrylate | % by mass | 1.1 | | |
| | | | mol % | 1.3 | | |
| | Polymeri- | Dimethyl 2,2′- | % by mass | | 0.037 | |
| | zation | azobis (isobutyrate) | mol % | | 0.016 | |
| | initiator | 2,2′-azobis (4-methoxy-2,4- | % by mass | | | 1.00 |
| | | dimethylvarelonitrile) | mol % | | | 0.325 |
| | Chain | n-octyl mercaptan | % by mass | | 0.270 | |
| | transfer | | mol % | | 0.185 | |
| | agent | | | | | |
| Ratio of | Chain transfer agent/ | | Molar | | 12/1 | |
| amounts of | polymerization initiator | | ratio | | | |
| materials | | | | | | |
| used | | | | | | |
| Polymerization conversion | | | % | | 96 | |
| | | | | Comparative | Comparative | Comparative |
| | | | | Example | Example | Example |
| Item | | | Unit | 1 | 2 | 3 |
| Physical | Methacrylic | Chain transfor agent | % by mass | | 0.0104 | |
| properties | resin | residual proportion in the | | | | |
| | | methacrylic resin before | | | | |
| | | purification | | | | |
| | | Chain transfer agent | % by mass | | 0.0001 | |
| | | residual proportion in the | | | | |
| | | methacrylic resin after | | | | |
| | | purification | | | | |
| | | Syndictacticity | % | 51 | 58 | 60 |
| | | Weight average molecular | — | 91,000 | 92,000 | 911,000 |
| | | weight (Mw) | | | | |
| | | Weight average molecular | — | 1.68 | 1.68 | 4.39 |
| | | weight (Mw)/Number average | | | | |
| | | molecular weight (Mn) | | | | |
| | | Proportion of terminal | mol % | 0.005 | 0.004 | 0.015 |
| | | double bonds | | | | |
| | | Glass transition | ° C. | 115 | 123 | 124 |
| | | temperature (Tg) | | | | |
| | | 5% weight loss | ° C. | 333 | 328 | 259 |
| | | temperature (Td5) | | | | |
| | Dope | Dope viscosity | Poise | 1.9 | 1.6 | |
| | Resin film | Glass transition | ° C. | 116 | 123 | |
| | (before | temperature (Tg) | | | | |
| | stretching) | | | | | |
| | Resin film | Haze | % | 0.11 | 0.45 | |
| | (after | Internal haze | % | 0.04 | 0.27 | |
| | stretching) | Total light transmittance | % | 92.5 | 92.6 | |
| | | YI | — | 0.17 | 0.33 | |
| | | Number of folds until | Number of | 3,000- | 1,000 - | |
| | | break in clamshell-type | folds | 4,500 | 2,000 | |
| | | folding test | | | | |

As shown in Tables 1 and 2, in Examples 1 to 7, a methacrylic resin having a high syndiotacticity and, as a result, a high glass transition temperature (Tg) and a resin film containing the methacrylic resin were obtained. In Examples 1 to 7, since the weight average molecular weight (Mw) of the methacrylic resin was large, the resin film exhibited excellent folding endurance. Specifically, the resin film after stretching in Example 1 did not break even when folds exceeded 20,000, the resin film after stretching in Example 2 did not break until the number of folds reached 11,000 to 13,000, the resin film after stretching in Example 3 did not break even when the number of folds exceeded 20,000, and the resin films after stretching in Examples 4 to 7 did not break even when the number of folds exceeded 200,000. Further, in Examples 1 to 7, the 5% weight loss temperature (Td5) of the methacrylic resin exceeded 300° C. That is, Examples 1 to 7 were all excellent in heat resistance (glass transition temperature (Tg)), thermal stability (5% weight loss temperature (Td5)), and mechanical properties (folding endurance) of the molded article.

On the other hand, as shown in Table 3, in Comparative Example 1, although the 5% weight loss temperature (Td5) of the methacrylic resin was high, the syndiotacticity was low, and as a result, the glass transition temperatures (Tg) of the methacrylic resin and the resin film were lower than those of Examples 1 to 3. In Comparative Example 1, since the weight average molecular weight (Mw) of the methacrylic resin was small, the mechanical properties of the resin film were poorer than those of Examples 1 to 3. Specifically, with the resin film after stretching of Comparative Example 1, the number of folds until break was only in the range of 3,000 to 4, 500.

In Comparative Example 2, a methacrylic resin and a resin film having a high syndiotacticity and a high glass transition temperature (Tg) were obtained, and the 5% weight loss temperature (Td5) of the methacrylic resin was also high. However, since the weight average molecular weight (Mw) of the methacrylic resin was small, the mechanical properties of the resin film were poorer than those of Examples 1 to 3. Specifically, in the resin film after stretching of Comparative Example 2, the number of folds until break was only in the range of 1,000 to 2,000.

In Comparative Example 3, a methacrylic resin having a high syndiotacticity and a high glass transition temperature (Tg) was obtained. However, since the proportion of terminal double bonds of the methacrylic resin was large, the 5% weight loss temperature (Td5) was lower than 300° C., and the thermal stability was low.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A methacrylic resin comprising a structural unit derived from methyl methacrylate in a proportion of 98% by mass or more,
wherein the methacrylic resin has:
a weight average molecular weight (Mw) as measured by gel permeation chromatography (GPC) of 400,000 or more,
a triad syndiotacticity of 55% to 70% inclusive,
a 5% weight loss temperature of 300° C. or higher, and
a proportion of terminal double bonds to the structural unit derived from methyl methacrylate of less than 0.015 mol %.

2. The methacrylic resin according to claim 1, wherein a ratio (Mw/Mn) of a weight average molecular weight (Mw) to a number average molecular weight (Mn) is 1.6 to 2.8 inclusive.

3. The methacrylic resin according to claim 1, wherein a chain transfer agent residual proportion is 0.005% by mass or less.

4. The methacrylic resin according to claim 2, wherein the chain transfer agent residual proportion is 0.005% by mass or less.

5. The methacrylic resin according to claim 1, comprising a terminal structure derived from a polymerization initiator and represented by the following formula (1). 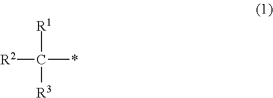
in the formula (1), R¹, R², and R³ each independently represent an alkyl group, a substituted alkyl group, an ester group, or an amide group, provided that at least one of R¹, R², or R³ represents an ester group or an amide group, two of R¹, R², or R³ may be bonded to each other to form an alicyclic structure, and * represents a bond to a structural unit derived from a monomer.

6. The methacrylic resin according to claim 1, having a glass transition temperature of 120° C. or more.

7. A methacrylic resin comprising a structural unit derived from methyl methacrylate in a proportion of 98% by mass or more,
wherein the methacrylic resin has:
a weight average molecular weight (Mw) as measured by gel permeation chromatography (GPC) of 400,000 or more,
a triad syndiotacticity of 55% or more,
a 5% weight loss temperature of 300° C. or higher,
a proportion of terminal double bonds to a structural unit derived from methyl methacrylate of less than 0.015 mol %, and
a glass transition temperature of 120° C. to 135° C. inclusive.

8. A method for producing a methacrylic resin, comprising:
a polymerization step of polymerizing a monomer mixture having a methyl methacrylate content of 98% by mass or more at a temperature lower than 100° C. in the presence of a polymerization initiator and a chain transfer agent until a polymerization conversion ratio reaches 90% or more,
wherein:
an amount of the chain transfer agent is 0.03 mol % or less with respect to a total amount of the monomer mixture, and
a ratio of a total molar amount of the chain transfer agent to a total molar amount of the polymerization initiator is 1.6 or less.

9. The method for producing a methacrylic resin according to claim 8, wherein the polymerization initiator is a non-nitrile azo polymerization initiator.

10. The method for producing a methacrylic resin according to claim 8, wherein aqueous polymerization is performed in the polymerization step.

11. The method for producing a methacrylic resin according to claim 8, wherein in the polymerization step, polymerization is performed until the chain transfer agent residual proportion reaches 0.005% by mass or less.

12. A resin composition comprising the methacrylic resin according to claim 1, and optionally multilayer structure polymer particles.

13. A dope for film formation by a solution casting method, the dope comprising the methacrylic resin according to claim 1 and a solvent,
wherein the solvent comprises a first solvent having a hydrogen bond term OH in a Hansen solubility parameter of 1 to 12 and a second solvent having the hydrogen bond term OH of 14 to 24.

14. A resin film comprising the methacrylic resin according to claim 1.

15. The resin film according to claim 14, wherein a number of folds until break in a clamshell-type folding test is 6,000 times or more.

16. The resin film according to claim 14, further comprising multilayer structure polymer particles.

17. The resin film according to claim 14, wherein the resin film is an optical film.

18. The resin film according to claim 14, wherein the resin film is a polarizer protective film.

19. A polarizing plate formed by laminating a polarizer and the resin film according to claim 14.

20. A display device comprising the polarizing plate according to claim 19.
